(19) United States
(12) Patent Application Publication
(10) Pub. No.: US 2017/0358931 A1
(43) Pub. Date: Dec. 14, 2017

(54) CHARGING METHOD AND ELECTRONIC DEVICE

(71) Applicant: Lenovo (Beijing) Co., Ltd., Beijing (CN)

(72) Inventors: Keming YUAN, Beijing (CN); Hao ZHU, Beijing (CN)

(21) Appl. No.: 15/616,389

(22) Filed: Jun. 7, 2017

(30) Foreign Application Priority Data
Jun. 13, 2016 (CN) 201610410766.6

(51) Int. Cl. H02J 7/00; G05B 19/042

(52) U.S. Cl. CPC H02J 7/007; H02J 7/0047; G05B 19/042; G05B 2219/25357; H02J 2007/0096; H02J 2007/005

(57) ABSTRACT

A charging method is provided for an electronic device. The charging method includes monitoring a current capacity of a battery coupled to a first electronic device to obtain a current level of remaining power in the battery and receiving a control command. The control command is used to instruct the first electronic device to enable a charging module and then to use the charging module to charge a second electronic device based on the current level of the remaining power in the battery. The charging method also includes receiving an operation command. In response to the operation command, the charging method further includes determining a first capacity of the battery based on the current level of the remaining power in the battery, and then controlling the charging module to provide electric power for the second electronic device based on the first capacity of the battery.

### CROSS-REFERENCES TO RELATED APPLICATIONS

This application claims priority of Chinese Patent Application No. 201610410766.6, filed on Jun. 13, 2016, the entire contents of which are hereby incorporated by reference.

### FIELD OF THE INVENTION

The present disclosure generally relates to the field of electronic technology and, more particularly, relates to a charging method and an electronic device.

### BACKGROUND

With the development and the popularity of wireless charging techniques, many mobile smart devices, especially devices with large battery capacities, may be equipped with wireless charging features. Therefore, a portion of the electric power may be transferred to other electronic devices through a wireless manner when it is needed.

However, current charging devices are merely used as energy sources, and often do not have control on the specific amount of the output power or the charging mode for power output. For example, current charging devices often are unable to control the frequency used for charging, or the time for power output, etc. Therefore, after the charging function is enabled, the battery life of the charging device may be short and the charging device may be unable to efficiently save energy.

Accordingly, current charging devices often are unable to control the charging mode used to output power and, thus, may cause certain technical problems of these charging devices such as short battery life or standby time and ineffective use of power resources. The disclosed charging method and electronic device are directed to solve one or more problems set forth above and other problems.

### BRIEF SUMMARY OF THE DISCLOSURE

A first aspect of the present disclosure is a charging method. The charging method includes monitoring a current capacity of a battery coupled to a first electronic device to obtain a current level of remaining power in the battery, and receiving a control command. The control command is used to instruct the first electronic device to enable a charging module and then to use the charging module to charge a second electronic device based on the current level of the remaining power in the battery. The charging method also includes receiving an operation command. In response to the operation command, the charging method further includes determining a first capacity of the battery based on the current level of the remaining power in the battery, and then controlling the charging module to provide electric power for the second electronic device based on the first capacity of the battery.

A second aspect of the present disclosure is an electronic device. The electronic device includes a charging module and a processor coupled to the charging module. The processor is configured to monitor a current capacity of a battery coupled to the electronic device to obtain a current level of remaining power in the battery and to receive a control command. The control command is used to instruct the electronic device to enable the charging module and then to use the charging module to charge a second electronic device based on the current level of the remaining power in the battery. The processor is also configured to receive an operation command. Moreover, in response to the operation command, the processor of the electronic device is further configured to determine a first capacity of the battery based on the current level of the remaining power in the battery, and control the charging module to provide electric power for the second electronic device based on the first capacity of the battery.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of an example of charging methods consistent with the disclosed embodiments;

FIG. 2 illustrates a structural diagram of an example of electronic devices consistent with disclosed embodiments;

FIG. 3 illustrates two battery symbols consistent with disclosed embodiments; and

FIG. 4 illustrates a battery symbol with touch-control characters consistent with disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts. The described embodiments are some but not all of the embodiments of the present invention. Based on the disclosed embodiments and without inventive efforts, persons of ordinary skill in the art may derive other embodiments consistent with the present disclosure, all of which are within the scope of the present invention.

The disclosed embodiments in the present disclosure are merely examples for illustrating the general principles of the invention. Any equivalent or modification thereof, without departing from the spirit and principle of the present invention, falls within the true scope of the present invention.

Moreover, in the present disclosure, the term “and/or” may be used to indicate that two associated objects may have three types of relations. For example, “A and/or B” may represent three situations: A exclusively exists, A and B coexist, and B exclusively exists. In addition, the character “/” may be used to indicate an “exclusive” relation between two associated objects.

The present disclosure provides improved charging methods and electronic devices. According to the present disclosure, by monitoring the current capacity of a battery coupled to a first electronic device, the current level of the remaining power in the battery is obtained. After receiving a control command that requests to charge a second electronic device, a first capacity of the battery is determined based on the current level of the remaining power in the battery, and then the first electronic device is controlled to charge the second electronic device based on the first capacity of the battery. As such, a requested amount of the electric power can be used as the amount of output power to charge the second electronic device. Therefore, the disclosed charging methods and electronic devices may improve the battery life or standby time of charging sources and may also improve the efficiency of the use of power resources.

FIG. 1 illustrates a flow chart of an example of charging method consistent with the disclosed embodiments. The charging method may include the following steps.

Step 101: Monitoring the current capacity of a battery to obtain the current level of the remaining power in the battery.

The battery may refer to a device that stores or carries a certain amount of electric power and is also able to transfer the stored or carried electric power to another device that needs to be charged and to serve as the power source of the device to be charged. Moreover, the device that needs to be charged may be an electronic device different from the device that the battery belongs to or is connected to. The remaining power in the battery may refer to all available electric power in the battery.

Step 102: Receiving or acquiring a control command. The control command may be used to instruct a first electronic device to enable a charging module, and then the charging module may charge a second electronic device based on the current level of the remaining power in the battery.

The first electronic device may refer to any appropriate device that can transfer electric power to a rechargeable device. For example, the first electronic device may be a charger, a smart power socket, a computer, a cellphone, or any other appropriate electronic device that can be used to charge another electronic device.

The battery may be a battery in the first electronic device or may be a battery connected to the first electronic device. That is, the battery may be coupled to the first electronic device. The control command may refer to a command to initiate using the first electronic device to charge the second electronic device.

Further, the control command may be automatically generated once a preset condition is satisfied. For example, when the second electronic device is connected to the first electronic device, a charging system may automatically generate a preset control command to enable the connect-and-charge function of the first electronic device. The connection between the first electronic device and the second electronic device may be wired or wireless.

For another example, the control command may also be automatically-generated when the system time of the first electronic device or the second electronic device reaches a preset time or a preset time range. For instance, in a case that the first electronic device is a rechargeable cellphone, when the system time of the cellphone reaches a time range, e.g., from 0:00 am to 8:00 am, the control command may be generated to charge other devices using the cellphone. Specifically, in the time range from 0:00 am to 8:00 am, the cellphone user is usually in sleep, the cellphone may only be used occasionally or may not be used at all, and the battery of the cellphone may have sufficient power. Therefore, to use the cellphone to charge other devices, the control command may only be generated when the electric power in the cellphone is sufficient or the current consumed electric power is under a threshold level.

In other examples, the control command may also be directly generated through user actions such that the charging function of the first electronic device may be enabled upon the user's request. For instance, the user may be able to generate the control command by touching the battery symbol schematically shown in FIG. 4.

Specifically, FIG. 4 illustrates a battery symbol with touch-control characters consistent with disclosed embodiments. Referring to FIG. 4, different touch-control characters may represent different percentages of the current remaining capacity and the corresponding charging time required. By using a finger or a touch pen to select a specific touch-control character, a control command including certain charging parameters may be generated.

In operation, the control command may be generated through a variety of ways based on the actual operation needs.

Step 103: Receiving or acquiring an operation command.

The operation command may be a command used to determine the amount of the electric power to be transferred to the second electronic device. That is, the operation command may include a parameter to describe the amount of electric power that needs to be transferred to the second electronic device.

Similar to the control command, the operation command may also be directly generated through a user action or automatically generated when a certain preset condition is satisfied. For instance, when the current remaining capacity is more than 80% of the fully-charged power capacity of the battery, the remaining capacity of the battery may be regarded as sufficient, and an operation command corresponding to sufficient remaining battery capacity may then be automatically generated. Further, the parameter in the operation command used to indicate the amount of electric power requested for charging may be 60%. Accordingly, in response to the operation command, the first electronic device may use 60% of the current remaining capacity of the battery for charging. However, when the current remaining capacity is less than 50% of the fully-charged power capacity, the remaining capacity of the battery may be regarded as insufficient, and an operation command corresponding to insufficient remaining capacity may then be automatically generated. Further, the parameter in the operation command used to indicate the amount of electric power requested for charging may be 0. Accordingly, in response to the operation command, the first electronic device may not charge the second electronic device.

Therefore, according to the disclosed methods, operation commands with different values of the parameter may be generated based on different user actions or different preset conditions. During operation, the value of the parameter provided by the operation command may be selected as needed.

Step 104: In response to the operation command, a first capacity of the battery may be determined from the remaining power capacity of the batter based on the current level of the remaining power in the battery. Specifically, the first capacity of the battery may be smaller than or equal to the current level of the remaining power in the battery.

During the process to determine the first capacity of the battery, based on the value of the parameter provided by the operation command, the first capacity of the battery corresponding to the parameter may be determined.

For example, after the first electronic device enables the charging module to charge the second electronic device, the first electronic device may continue to generate a preset operation command to charge the second electronic device using the entire portion of the electric power in the battery. Therefore, the parameter of the operation command used to indicate the amount of the electric power requested for charging may correspond to the entire portion of the current level of the remaining power in the battery. Therefore, after receiving the operation command, the first electronic device may charge the second electronic device using all the remaining capacity of the battery. That is, the first capacity of the battery equals to the remaining capacity of the battery.

For another example, after the first electronic device enables the charging module to charge the second electronic device, the first electronic device may receive an operation command generated through a user-selected operation, and the parameter provided by the operation command may correspond to 30% of the current level of the remaining power in the battery coupled to the first electronic device. Therefore, after receiving the operation command, the first electronic device may charge the second electronic device using 30% of the current level of the remaining power in the battery. That is, the first capacity of the battery is 30% of the remaining power in the battery.

Therefore, the parameter provided by the operation command to describe the amount of the electric power used to charge the second electronic device may correspond to a portion of the current level of the remaining power in the battery. Further, during actual operation, the portion of the remaining electric power may be expressed as a percentage with respect to the fully-charged power capacity of the battery or as a percentage with respect to the current level of the remaining power in the battery.

During the operation process, Step 101, Step 102, Step 103, and Step 104 may or may not be executed following the order described above. For example, in one embodiment, Step 101, Step 102, Step 103, and Step 104 may be executed sequentially following the order. However, in another embodiment, Step 101 may be executed after the execution of Step 102, or Step 103 and Step 104 may be executed after the execution of Step 101 but before the execution of Step 102. In general, regardless of whether or not the execution of the steps follows the order described in the above embodiment, any charging method based on Steps 101-104, that picks out an entire or a portion of the current capacity of the remaining power in a battery coupled to the first electronic device to charge a second electronic device, is consistent with the disclosed embodiments.

Step 105: In response to the operation command, the charging module may be controlled to provide electric power for the second electronic device based on the first capacity of the battery. Specifically, during the operation process, the first capacity of the battery determined in Step 104 may be used to charge the second electronic device from the battery of the first electronic device.

Therefore, according to the present disclosure, the current capacity of the battery may be monitored to obtain the current level of the remaining power in the battery. After receiving a control command that requests to charge a second electronic device, a first capacity of the battery is determined based on the current level of the remaining power in the battery, and then the first electronic device may charge the second electronic device based on the first capacity of the battery. As such, according to the current level of the remaining power in the battery coupled to the first electronic device, the disclosed method may be able to determine a certain amount of electric power used for charging from the current level of the remaining power in the battery based on user or system requests. Further, the determined amount of electric power may be used to charge the second electronic device. Therefore, the disclosed charging method may be able to control the amount of electric power used to charge the second electronic device based on user request as well as the remaining power in the battery. Thus, the disclosed charging method may improve the battery life or standby time as well as the efficiency of the use of power resources.

Optionally, controlling the charging module to provide electric power for the second electronic device based on the first capacity of the battery may further include generating and displaying a prompt message. The prompt message may be used to schematically illustrate the transfer of the first capacity of the battery to the second electronic device as a second capacity. The second capacity may correspond to a portion of the power in a battery coupled to the second electronic device that is obtained through the transfer process.

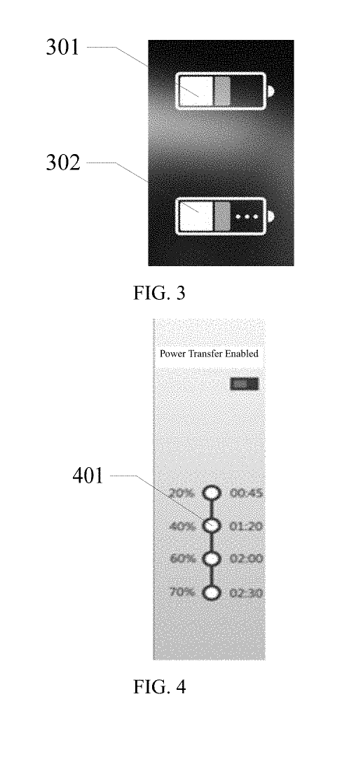

The transfer process may indicate the power in the first capacity of the battery that has been transferred to the second electronic device, or the power in the first capacity of the battery that still needs to be transferred. For example, referring to FIG. 3, a gray area and a black area in a battery symbol 301 together may represent the current capacity of the remaining power in the battery.

As shown in FIG. 3, the total size of the gray area and the black area is approximately 50% of the entire size of the battery symbol, representing that the current level of the remaining power in the battery is about 50% of the fully-charged power capacity of the battery. Further, the gray area may represent the portion of the electric power that needs to be transferred to the second electronic device through the first electronic device. That is, the gray area may represent the first capacity of the battery.

Moreover, compared to the battery symbol 301, the battery symbol 302 shows three additional dots. These three dots are used to indicate that the first capacity of the battery is in a transfer process. During actual operation, to more clearly illustrate the charging process, an animation display of the three points may be used to represent that charging is in progress. For example, the three small dots may be enlarged one after another through the animation display to represent an active charging process. Moreover, the animation display may be repeated during the charging process.

Further, any symbol, voice message, text message, symbolic message, or other message that may be used to remind the user about the progress or the status of the transfer of the first capacity of the battery may be used as the prompt message.

In one embodiment, during actual operation, the prompt message may be generated by the first electronic device or by the second electronic device. Moreover, the prompt message may also be generated by a master device or by a preset device controlled by a master device. The method used to generate the prompt message may be determined based on the actual needs during the operation process.

Therefore, according to the disclosed methods, a prompt message may be used to notify the user of the status of the transfer of the first capacity of the battery to the second electronic device. Further, because the disclosed methods may also notify the user of the current progress of the electric power transfer, the disclosed methods may improve user experience during the charging process.

Optionally, the acquisition of the operation command may include the following aspects.

An output module of the first electronic device may send out the current remaining capacity using a first output method to inform the user of the current level of the remaining power in the battery.

In addition, during the process to obtain a selection operation performed based on the first output method, a first operation command corresponding to the selection operation may be obtained.

Further, responding to the operation command may include, in response to the first operation command, determining a range of the battery power corresponding to the selection operation as the first capacity of the battery. The determined range of the battery power may be smaller than or equal to the current level of the remaining power in the battery. That is, during the process to receive or acquire the operation command from the user to determine the first capacity of the battery, according to the method used by the first electronic device to notify the user of the current level of the remaining power in the battery, a corresponding operation may be performed to determine the first capacity of the battery.

For example, when the first electronic device uses a symbol to display output, the touch screen may show a half-empty and half-black-color-filled battery symbol to represent that the current remaining capacity is 50% of the fully-charged power capacity of the battery. Further, a user may use a finger or a touch pen to select the portion of the electric power that needs to be used for charging from the black portion of the battery symbol. During actual operation, the touch screen may keep detecting whether user's finger or touch pen is close to or in contact with the battery symbol. When the detection indicates that user's finger or touch pen is close to or in contact with the battery symbol, the displayed battery symbol may be magnified to facilitate user's operation.

For another example, referring to FIG. 4, the first capacity of the battery may also be selected through a plurality of displayed touch-control characters of the first electronic device. Referring to FIG. 4, different touch-control characters may represent different percentages of the current remaining capacity and the corresponding charging time required. For example, touch-control character 401 may represent that the current remaining capacity is about 40% of the fully-charged power capacity of the battery, and the charging time corresponding to the current remaining capacity is one hour and twenty minutes. By selecting the touch-control character 401 though a touching operation, a 40% of the current level of the remaining power in the battery to the second electronic device may be requested for charging, and the time used to complete the charging process is expected to be about one hour and twenty minutes.

For another example, the first electronic device may use a voice output to inform the user of the current level of the remaining power in the battery. For example, the sound unit of the first electronic device may send out a voice message indicating the current remaining capacity is about 80% of the fully-charged power capacity of the battery. Based on the voice message, the user may also use a voice message to determine the first capacity of the battery. For example, the user may send out a voice message, ‘50%’, to determine 50% of the current level of the remaining power in the battery as the first capacity of the battery.

According to the disclosed methods, based on the method used by the first electronic device to notify the user of the current level of the remaining power in the battery, a corresponding operation may be performed to determine the first capacity of the battery. Therefore, the disclosed methods may improve the efficiency in defining the first capacity of the battery and may further improve user experience.

Optionally, the process to control the charging module to charge the second electronic device based on the first capacity of the battery may further include the following aspects.

During the process to control the charging module to charge the second electronic device based on the first capacity of the battery, the battery may also provide electric power for electronic modules of the first electronic device. The electronic modules of the first electronic device may at least include the charging module.

The charging module providing electric power for the second electronic device based on the first capacity of the battery may include two aspects. First, the charging module may provide electric power for the second electronic device to ensure the normal operation of the second electronic device. Second, the charging module may also charge the battery of the second electronic device to increase the power storage in the battery of the second electronic device.

Thus, according to the disclosed charging methods, in addition to using the remaining capacity in the battery to supply electric power to the second electronic device or charge the battery of the second electronic device, the first electronic device may also provide electric power for one or more electronic modules of the first electronic device to ensure normal operation of the one or more electronic modules of the first electronic device. Moreover, the one or more electronic modules may at least include the charging module.

Therefore, according to the disclosed charging methods, the battery may give priority to providing electric power for the charging module. As such, even the electric power supply from the battery to the other electronic modules of the first electronic device is stopped, as long as the first electronic device is in a process to supply electric power to the second electronic device or to charge the battery of the second electronic device, the battery may give priority to providing electric power for the charging module, and thus may prevent the charging module from stopping working due to power failure and also prevent other electronic devices from even being damaged or burnt-out during the charging process. Therefore, the disclosed charging methods may be able to improve the charging safety and also reduce the failure rate.

Optionally, during the process that the charging module provides electric power for the second electronic device based on the first capacity of the battery, the battery may also provide electric power for the electronic modules of the first electronic device. Moreover, providing electric power for the electronic modules of the first electronic device may include that the first electronic device dynamically adjusts the power supply strategy of using the battery to provide electric power for the electronic modules of the first electronic device in order to meet a preset condition.

That is, during the process of using the first electronic device to charge the second electronic device, the disclosed methods may also keep monitoring whether some preset parameters or preset status are changed and exceed predetermined ranges according to the preset condition. Specifically, some preset parameters or preset status exceeding predetermined corresponding ranges may represent that events requiring immediate response may have taken place. Therefore, the preset condition may serve as the judgment criteria to determine whether events requiring immediate response have taken place according to the preset parameters or the preset status.

For example, during the charging process, when the real-time detection indicates that the fluctuation amplitude of the charging current exceeds a threshold value, the charging status is then regarded as unstable. Accordingly, the first electronic device may immediately enable a voltage regulator to reduce the fluctuation amplitude of the charging current or stop the charging process to let the charging current return back to zero. Therefore, a proper action ensuring the safety of the first electronic device may be made in response to such an event in which the fluctuation amplitude of the charging current exceeds a threshold value. In the case described above, the charging current exceeding a threshold fluctuation amplitude may be used as the preset condition.

For another example, during the charging process, when the real-time detection indicates that the environment temperature of the charging process exceeds a threshold value, the environment temperature is then regarded as unsuitable for charging. Accordingly, the first electronic device may immediately enable a cooling system to reduce the environment temperature or stop the charging process to let the environment temperature decrease. Therefore, a proper action ensuring the safety of the first electronic device may be made in response to such an event where the environment temperature of the charging process exceeds a threshold value. In the case described above, the environment temperature of the charging process exceeding a threshold value may be used as the preset condition.

According to the disclosed methods, the preset condition may be determined based on different application requirements, and the first electronic device may then be able to dynamically adjust the power supply strategy based on the preset condition to meet the different requirements. Therefore, the disclosed charging methods may be able to further improve the applicability.

Optionally, the process that the first electronic device dynamically adjusts the power supply strategy of using the battery to provide electric power for the electronic modules of the first electronic device may include adjusting the electric power supply for certain preset electronic modules of the first electronic device from the battery such that the current electric power consumption of the first electronic device is smaller than or equal to a first preset electric power consumption; or stopping certain preset application programs in the first electronic device such that the current electric power consumption of the first electronic device is smaller than or equal to a second preset electric power consumption.

That is, during the charging process, when the first electronic device detects in real-time that the current self-consumption of electric power exceeds a threshold value, the self-power-consumption is then regarded as relatively high, and it is no longer suitable for the first electronic device to simultaneously charging other electronic devices. In response, by adjusting the electric power supply for certain preset electronic modules of the first electronic device from the battery or by stopping certain preset non-essential application programs in the first electronic device, the self-power-consumption of the first electronic device may be reduced.

For example, when the first electronic device is in a sleep state and the first electronic device detects in real-time that the self-power-consumption exceeds the threshold value corresponding to the sleep state, the first electronic device may turn off the power supply to electronic modules other than the charging module so that a continuous charging process is ensured and the self-power-consumption is also reduced.

For another example, when the first electronic device is in a normal operation state and the first electronic device detects in real-time that the self-power-consumption exceeds the threshold value corresponding to the normal operation state, the first electronic device may stop certain preset application programs, such as game applications, interface optimization applications, etc., and only keep essential applications running to ensure the normal operation of the first electronic device and also to reduce the self-power-consumption.

Therefore, according to disclosed embodiments, when the self-power-consumption of the first electronic device exceeds a threshold value, the disclosed methods may adjust the electric power supply for certain preset electronic modules of the first electronic device from the battery or stop certain preset non-essential application programs in the first electronic device to reduce the self-power-consumption. Thus, when the battery is used to provide electric power for the first electronic device, the disclosed charging methods may effectively improve the battery life or standby time for the first electronic device.

Optionally, after the charging module is enabled to provide electric power for the second electronic device based on the first capacity of the battery, the charging method may include detecting whether a preset function of the first electronic device is enabled. After it is determined that a preset function is enabled, the charging method may further include generating and performing a termination command to stop the first electronic device from providing electric power for the second electronic device.

The preset function may be a call function, a flashlight function, a game function, or a video playback function, etc. In general, any function that can be realized by the first electronic device, certain types of executable application programs, as well as various application programs within predetermined ranges may be used as preset functions. During actual operation, the preset function may be configured by the user or may be a preset function set by the system.

For example, the first electronic device is a cellphone. While the cellphone is being used to charge a smart watch, the cellphone receives a call and the user answers. That is, the call function of the cellphone is enabled. Accordingly, the charging process may be terminated to prevent an excessively large current in the cellphone from damaging the electronic components and affecting the charging results. In the meantime, the quality of the phone call is also ensured.

Therefore, according to the disclosed charging methods, when a preset function is enabled during the charging process, the electric power supply for the second electronic device may be stopped in order to avoid damages and undesired charging effects due to an excessively large internal current in the cellphone. Thus, the safety of the electronic device may be improved and the stability of the system may also be improved.

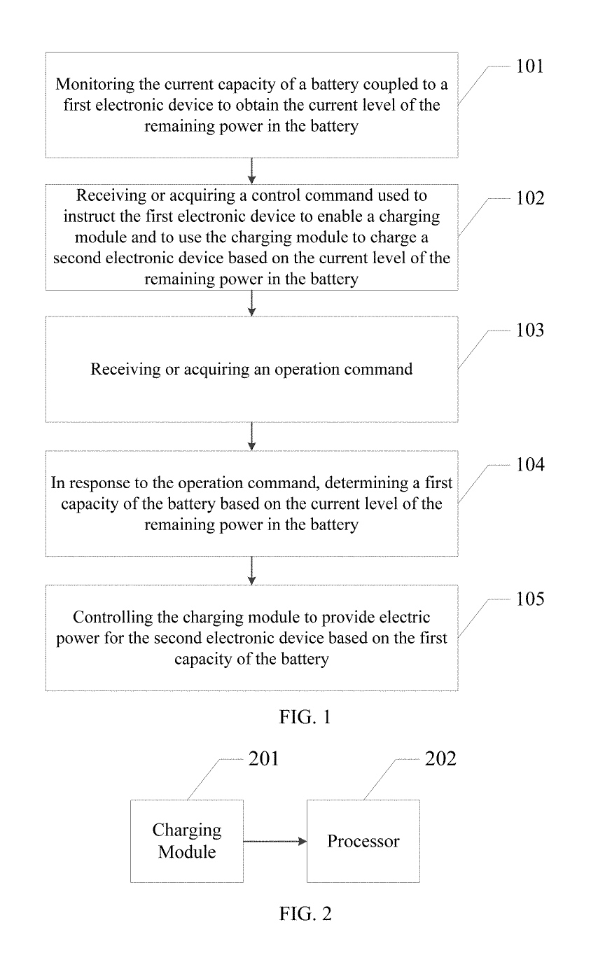

The present disclosure also provides an electronic device corresponding to the disclosed charging method. FIG. 2 illustrates a structural diagram of an example of electronic devices consistent with various disclosed embodiments. The electronic device may include a charging module 201 and a processor 202 coupled to the charging module. Other components may also be included.

The processor 202 may be used to monitor the current capacity of a battery to obtain the current level of the remaining power in the battery. The battery may be a battery coupled to an electronic device. The processor 202 may also be used to receive or acquire a control command. The control command may be used to instruct the charging module to charge other electronic devices based on the electric power provided by the battery.

Further, the processor 202 may also be used to receive or acquire an operation command and respond to the obtained operation command. The operation command may be used to determine a first capacity of the battery based on the current level of the remaining power in the battery. Moreover, the first capacity of the battery may be smaller than or equal to the current level of the remaining power in the battery. Further, in response to the control command, the charging module 201 may be controlled to provide electric power for other electronic devices based on the first capacity of the battery.

In one embodiment, the processor 202 may be a general-purpose central processing unit (CPU) or an application specific integrated circuit (ASIC). In other embodiments, the processor 202 may also be one or more integrated circuits (ICs) used to control the execution of programs.

Further, the electronic device may also include a plurality of storage devices. The number of the storage devices may be one or more than one. The storage devices may include read only memory (ROM), random access memory (RAM), magnetic disks, etc.

Optionally, the processor 202 may be used to generate and display a prompt message. The prompt message may be used to schematically illustrate the transfer of the first capacity of the battery to the second electronic device as a second portion of electric power.

Optionally, through an output module of the electronic device, the processor 202 may send out the current remaining capacity of the battery using a first output method to inform the user of the current level of the remaining power in the battery. Further, during the process to obtain a selection operation performed based on the first output method, a first operation command corresponding to the selection operation may be obtained. Moreover, in response to the first operation command, a range of the battery power corresponding to the selection operation may be determined as the first capacity of the battery. The determined range of the battery power may be smaller than or equal to the current level of the remaining power in the battery.

Optionally, while the charging module is controlled to provide electric power for other electronic devices based on the first capacity of the battery, the processor 202 may also control the battery to provide electric power for the electronic modules of the electronic device. Specifically, the electronic modules of the electronic device may at least include the charging module.

Optionally, to meet a preset condition, the processor 202 may dynamically adjust the power supply strategy of using the battery to provide electric power for the electronic modules of the electronic device.

Optionally, the processor 202 may adjust the electric power supply for certain preset electronic modules of the electronic device from the battery such that the current electric power consumption is smaller than or equal to a first preset electric power consumption. Alternatively, the process 202 may stop certain preset non-essential application programs in the electronic device such that the current electric power consumption is smaller than or equal to a second preset electric power consumption.

Optionally, the processor 202 may be used to detect whether the electronic device enables a preset function. When the processor 202 detects that a preset function is enabled, a termination command may be generated and executed to stop the electronic device from providing electric power for the other electronic devices.

Moreover, the charging method illustrated in FIG. 1 may be applicable to the electronic devices disclosed in various embodiments of the present disclosure. Therefore, referring to the above description of the disclosed charging method, a skilled person in the field may understand the implementation methods of the disclosed electronic devices.

According to the present disclosure, by monitoring the current capacity of a battery coupled to an electronic device, the current level of the remaining power in the battery is obtained. After receiving a control command that requests to charge other electronic devices, a first capacity of the battery is determined from the remaining electric power of the battery based on the current level of the remaining power in the battery, and then the electronic device is controlled to transfer electric power to other electronic devices based on the first capacity of the battery. As such, according to the current level of the remaining power in the battery coupled to the electronic device, the disclosed method may be able to determine a certain amount of electric power used for charging from the current level of the remaining power in the battery based on user or system requests. Further, the determined amount of electric power may be used to charge the other electronic devices. Therefore, the disclosed charging method may be able to control the amount of electric power used to charge electronic devices based on user request as well as the remaining power in the battery. Thus, the disclosed charging method may improve the battery life or standby time as well as the efficiency of the use of power resources.

The disclosed charging method and electronic device may demonstrate at least the following features.

During the transfer of the first capacity of the battery to other electronic devices, the disclosed charging method and electronic device may notify the user of the present status of the transfer process through a displayed prompt message. Therefore, the disclosed charging method and electronic device may be able to expand the applicability of charging devices and also improve user experience in the charging process.

Further, by notifying the user of the current remaining capacity of the battery, the disclosed charging method and electronic device may allow the user to determine the first capacity of the battery based on the current remaining capacity. Therefore, the disclosed charging method and electronic device may also be able to improve the efficiency in determining the first capacity of the battery and also further improve user experience.

Further, according to the disclosed charging method and electronic device, in addition to charging other electronic devices using the electric power in the battery, the electronic device may also use the electric power in the battery to provide electric power for one or more electronic modules of the electronic device. Moreover, the one or more electronic modules may include at least the charging module. Therefore, the disclosed charging method and electronic device may prevent the charging module from stop working or other electronic devices from being damaged or burnt-out during the charging process due to power failure. Thus, the disclosed charging method and electronic device may be able to improve the charging safety and also reduce the failure rate.

Further, the disclosed method and electronic device may set a plurality of preset conditions based on various application requirements. Therefore, the electronic device may dynamically adjust the power supply strategy based on the preset conditions to meet various application requirements. Thus, the disclosed method and the electronic device may be able to further improve the applicability.

Further, when the self-power-consumption of the disclosed electronic device exceeds a threshold value, the disclosed method and electronic device may adjust the electric power supply for certain preset electronic modules of the electronic device from the battery or stop certain preset non-essential applications to reduce the self-power-consumption. Therefore, when the battery provides electric power for other electronic devices, the disclosed charging method may effectively improve the battery life or standby time for the electronic device.

Further, the disclosed charging method and electronic device may enable a preset function to stop providing electric power for other electronic devices. Therefore, the disclosed charging method and electronic device may avoid damages and undesired charging effects due to an excessively large current in the cellphone, and thus, the safety of the electronic device may be improved and the stability of the system may also be improved.

Moreover, embodiments consistent with the present disclosure may provide a variety of methods, systems, and computer program products. That is, various embodiments consistent with the present disclosure may be in the forms of methods, systems, and computer program products. Therefore, embodiments consistent with the present disclosure may be all-hardware based, all-software based, or combinations of both hardware and software. In addition, embodiments consistent with the present disclosure may also be computer program products operated on computer-based storage media that include computer-based programming code. The computer-based storage media may include magnetic storage disk, compact disk read-only memory (CD-ROM), optical memory, and other appropriate storage media.

The present disclosure is described based on the flow chart and/or the block diagram of methods, devices (systems), and computer program products consistent with various embodiments of the present disclosure. The present disclosure may include not only individual procedure and/or individual block of the flow chart and/or the block diagram but also the combinations of the procedures and/or the blocks of the flow chart and/or the block diagram that can be realized by computer program commands. These computer program commands may be sent to a processor of a general-purpose computer, a special-purpose computer, an embedded processing system, or any other programmable data processing equipment to generate a machine. As such, a device used to realize specified functions of one or more procedures in the flow chart and/or specified functions of one or more blocks in the diagram may be generated by the commands operated by the computer or other programmable data processing equipment.

These computer program commands may also be stored in a computer-readable memory that can guide a computer or other programmable data processing equipment to work in a specific manner so that the commands stored in the computer-readable memory may generate a machine including an instruction device. The instruction device may be used to realize specified functions of one or more procedures in the flow chart and/or specified functions of one or more blocks in the diagram.

In addition, these computer program commands may also be loaded into a computer or other programmable data processing equipment so that the computer or the programmable equipment may execute a series of operation procedures to generate a computer-based implementation process. As such, commands executed on the computer or other programmable data processing equipment may provide execution procedures to realize specified functions of one or more procedures in the flow chart and/or specified functions of one or more blocks in the diagram.

For example, computer program commands corresponding to a charging method that is consistent with various embodiments of the present disclosure may be stored in storage media such as optical disc, hard disc, U disc, etc. Further, using an electronic device to read out or execute the computer program commands stored in the storage media and corresponding to a charging method may include the following steps.

The current capacity of a battery may be monitored to obtain the current level of the remaining power in the battery. A control command may then be received or acquired. The control command may be used to instruct a first electronic device to enable a charging module, and the charging module may charge a second electronic device based on the electric power provided by the battery. Further, an operation command may be received or acquired. In response to the operation command, a first capacity of the battery may be determined based on the current remaining power in the battery. The first capacity of the battery may be smaller than or equal to the remaining power in the battery. Moreover, in response to the control command, the charge module may be controlled to provide electric power for the second electronic device based on the first capacity of the battery.

Optionally, executing the computer program commands that correspond to controlling the charging module to provide electric power for the second electronic device based on the first capacity of the battery may further include generating and displaying a prompt message. The prompt message may be used to schematically illustrate the transfer of the first capacity of the battery to the second electronic device to serve as a second portion of electric power in a battery coupled to the second electronic device.

Optionally, the process to execute the computer program commands that correspond to receiving or acquiring the operation command may further include sending out the current remaining capacity through the output module of the first electronic device using a first output method to inform the user of the current level of the remaining power in the battery the following steps.

Further, during the process to obtain a selection operation performed based on the first output method, a first operation command corresponding to the selection operation may be obtained.

The process in response to the operation command may further include that in response to the first operation command, a range of the battery power corresponding to the selection operation may be determined as the first capacity of the battery. The selected range of the battery power may be smaller than or equal to the current level of the remaining power in the battery.

Optionally, the process to execute the computer program commands that correspond to controlling the charging module to provide electric power for the second electronic device based on the first capacity of the battery may further include the following steps.

During the process that the charging module provides electric power for the second electronic device based on the first capacity of the battery, the battery may also provide electric power for electronic modules of the first electronic device. The electronic modules of the first electronic device may include at least the charging module.

Optionally, during the process that the charging module provides electric power for the second electronic device based on the first capacity of the battery, the computer program commands corresponding to providing electric power from the battery for electronic modules of the first electronic device may also include that to meet a preset condition, the first electronic device may dynamically adjust the power supply strategy of using the battery to provide electric power for the electronic modules of the first electronic device.

Optionally, the process to execute the computer program commands that correspond to the first electronic device dynamically adjusting the power supply strategy of using the battery to provide electric power for the electronic modules of the first electronic device may further include the first electronic device adjusting the electric power supply for certain preset electronic modules of the first electronic device from the battery such that the current electric power consumption of the first electronic device is smaller than or equal to a first preset electric power consumption.

Alternatively, the process to execute the computer program commands that correspond to the first electronic device dynamically adjusting the power supply strategy of using the battery to provide electric power for the electronic modules may include, the first electronic device stopping certain preset non-essential application programs in the first electronic device such that the current electric power consumption of the first electronic device is smaller than or equal to a second preset electric power consumption.

Optionally, after the charging module is enabled to provide electric power for the second electronic device based on the first capacity of the battery, the execution of the computer program commands stored in the storage media may further include detecting whether the first electronic device enables a preset function. When it is detected that the first electronic device enables a preset function, a termination command may be generated and executed to stop the first electronic device from supplying electric power for the second electronic device.

The charging methods and electronic devices disclosed in the present disclosure may demonstrate the following technical effects.

According to the disclosed charging methods, the current capacity of a battery coupled to a first electronic device may be monitored to obtain the current level of the remaining power in the battery. Further, after receiving a control command that requests to charge a second electronic device, a first capacity of the battery may be determined based on the current level of the remaining power in the battery, and then the first electronic device may charge the second electronic device based on the first capacity of the battery. As such, according to the current level of the remaining power in the battery coupled to the first electronic device, the disclosed method may be able to determine a certain amount of electric power used for charging from the current level of the remaining power in the battery based on user or system requests. Further, the determined amount of electric power may be used to charge the second electronic device. Therefore, the disclosed charging method may be able to control the amount of electric power used to charge the electronic device that needs to be charged based on user request as well as the remaining power in the battery. Thus, the disclosed charging method may improve the battery life or standby time as well as the efficiency of the use of power resources.

Further, according to the disclosed methods, a prompt message may be used to notify the user of the present status of the transfer of the first capacity of the battery to the second electronic device. Therefore, the disclosed charging methods and electronic devices may be able to expand the applicability of charging devices and also improve user experience in the charging process.

Further, according to the disclosed charging methods and electronic devices, based on the method that the first electronic device uses to notify the user of the current remaining capacity, a corresponding operation may be performed to determine the first capacity of the battery. Therefore, the disclosed charging methods and electronic devices may improve the efficiency in determining the first capacity of the battery and may further improve user experience.

Further, according to the disclosed charging methods and electronic devices, in addition to charging other electronic devices using the electric power in the battery, the electronic device may also use the electric power in the battery to provide electric power for one or more electronic modules of the electronic device. The one or more electronic modules may include at least the charging module. Therefore, the disclosed charging methods and electronic devices may prevent the charging module from stop working or other electronic devices from being damaged or burnt-out during the charging process due to power failure. Thus, the disclosed charging methods and electronic devices may be able to improve the charging safety and also reduce the failure rate.

Further, the disclosed charging methods and electronic devices may set preset conditions based on various application requirements. Moreover, the electronic devices may dynamically adjust the power supply strategy based on the preset conditions to meet various application requirements. Thus, the disclosed charging methods and the electronic devices may be able to further improve the applicability of the disclosed charging methods and electronic devices.

Further, when the self-power-consumption of the disclosed electronic device exceeds a threshold value, the disclosed charging methods and electronic devices may adjust the electric power supply for certain preset electronic modules of the first electronic device from the battery or stop certain preset non-essential applications to reduce the self-power-consumption. Therefore, when the battery provides electric power for other electronic devices, the disclosed charging methods may effectively improve the battery life or standby time for the electronic device.

Further, the disclosed charging methods and electronic devices may enable a preset function to stop providing electric power for other electronic devices. Therefore, the disclosed charging methods and electronic devices may avoid damages and undesired charging effects due to an excessively large current, and thus, the safety of the electronic device may be improved and the stability of the system may also be improved.

Further, in the present disclosure, relational terms such as first, second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the present specification are described in a progressive manner, in which each embodiment focusing on aspects different from other embodiments, and the same and similar parts of each embodiment may be referred to each other. Because the disclosed devices correspond to the disclosed methods, the description of the disclosed devices and the description of the disclosed methods may be read in combination or in separation.

The description of the disclosed embodiments is provided to illustrate the present invention to those skilled in the art. Various modifications to these embodiments will be readily apparent to those skilled in the art, and the generic principles determined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A charging method, comprising:
monitoring a current capacity of a battery coupled to a first electronic device to obtain a current level of remaining power in the battery;
receiving a control command used to instruct the first electronic device to enable a charging module and to use the charging module to charge a second electronic device based on the current level of remaining power in the battery;
receiving an operation command;
in response to the operation command, determining a first capacity of the battery based on the current level of the remaining power in the battery; and
controlling the charging module to provide electric power for the second electronic device based on the first capacity of the battery.

2. The charging method according to claim 1, wherein controlling the charging module to charge the second electronic device based on the first capacity of the battery further includes:
generating and displaying a prompt message to illustrate transfer of the first capacity of the battery to the second electronic device as a second capacity of a battery coupled to the second electronic device.

3. The charging method according to claim 1, wherein receiving the operation command further includes:
informing the current level of the remaining power in the battery to a user by using an output module of the first electronic device to send out the current level of the remaining power in the battery through a first output method; and
in response to a selection operation performed based on the first output method, receiving a first operation command corresponding to the selection operation.

4. The charging method according to claim 3, further comprising:
assigning a range of the battery power corresponding to the selection operation as the first capacity of the battery in response to the first operation command, wherein the assigned range of the battery power is smaller than or equal to the current capacity of the battery.

5. The charging method according to claim 1, wherein controlling the charging module to charge the second electronic device based on the first capacity of the battery further includes:
providing power for electronic modules of the first electronic device from the battery, wherein the electronic modules of the first electronic device include at least the charging module.

6. The charging method according to claim 5, wherein providing power for the electronic modules of the first electronic device during the charging module charges the second electronic device based on the first capacity of the battery further includes:
dynamically adjusting a power supply strategy of the battery to provide power for the electronic modules of the first electronic device to meet a preset condition.

7. The charging method according to claim 6, wherein dynamically adjusting a power supply strategy of the battery to provide power for the electronic modules of the first electronic device further includes:
adjusting electric power supply for certain preset electronic modules of the first electronic device from the battery to ensure a current power consumption of the first electronic device to be smaller than or equal to a first preset power consumption.

8. The charging method according to claim 6, wherein dynamically adjusting a power supply strategy of the battery to provide power for the electronic modules of the first electronic device further includes:
stopping certain preset application programs in the first electronic device to ensure a current power consumption of the first electronic device to be smaller than or equal to a second preset power consumption.

9. The charging method according to claim 1, after controlling the charging module to provide power for the second electronic device based on the first capacity of the battery, further including:
detecting whether the first electronic device enables a preset function; and
after the preset function is enabled, generating and performing a termination command to stop the first electronic device from providing electric power for the second electronic device.

10. An electronic device, comprising:
a charging module; and
a processor coupled to the charging module,
wherein the processor is configured to:
monitor a current capacity of a battery coupled to the electronic device to obtain a current level of remaining power in the battery;
receive a control command used to instruct the electronic device to enable the charging module and to use the charging module to charge a second electronic device based on the current level of remaining power in the battery;
receive an operation command;
in response to the operation command, determine a first capacity of the battery based on the current level of the remaining power in the battery; and
control the charging module to provide electric power for the second electronic device based on the first capacity of the battery.

11. The electronic device according to claim 10, wherein the processor is also configured to:
generate and display a prompt message to illustrate transfer of the first capacity of the battery to the second electronic device as a second capacity of a battery coupled to the second electronic device.

12. The electronic device according to claim 10, wherein to receive the control command, the processor is configured to:
inform the current level of the remaining power in the battery to a user by using an output module of the electronic device to send out the current level of the remaining power in the battery through a first output method; and
in response to a selection operation performed based on the first output method, receive a first operation command corresponding to the selection operation.

13. The electronic device according to claim 12, wherein to receive the operation command, the processor is configured to:
assign a range of the battery power corresponding to the selection operation as the first capacity of the battery in response to the first operation command, wherein the assigned range of the battery power is smaller than or equal to the current capacity of the battery.

14. The electronic device according to claim 10, wherein the processor is further configured to:
provide power for electronic modules of the electronic device from the battery when the charging module is controlled to charge the second electronic device based on the first capacity of the battery, wherein the electronic modules of the electronic device include at least the charging module.

15. The electronic device according to claim 14, wherein to provide power for the electronic modules of the electronic device during the charging module charges the second electronic device based on the first capacity of the battery, the processor is further configured to:
dynamically adjust a power supply strategy of the battery to provide power for the electronic modules of the electronic device to meet a preset condition.

16. The electronic device according to claim 15, wherein to dynamically adjust a power supply strategy of the battery to provide power for the electronic modules of the electronic device, the processor is configured to:
adjust electric power supply for certain preset electronic modules of the electronic device to ensure a current power consumption of the electronic device to be smaller than or equal to a first preset power consumption.

17. The electronic device according to claim 15, wherein to dynamically adjust a power supply strategy of the battery to provide power for the electronic modules of the electronic device, the processor is configured to:
stop certain preset application programs in the electronic device to ensure a current power consumption of the electronic device to be smaller than or equal to a second preset power consumption.

18. The electronic device according to claim 10, wherein after the charging module is controlled to provide power for the second electronic device based on the first capacity of the battery, the processor is further configured to:
detect whether the electronic device enables a preset function; and
after the preset function is enabled, generate and perform a termination command to stop the electronic device from providing electric power for the second electronic device.
